(19) United States
(12) Patent Application Publication
(10) Pub. No.: US 2013/0166255 A1
(43) Pub. Date: Jun. 27, 2013

(54) COMPUTING DEVICE AND METHOD FOR EXTRACTING FEATURE ELEMENTS OF PRODUCT FROM DESIGN DRAWING

(71) Applicants: CHIH-KUANG CHANG, Tu-Cheng (TW); XIN-YUAN WU, Shenzhen City (CN); LU YANG, Shenzhen City (CN)

(72) Inventors: CHIH-KUANG CHANG, Tu-Cheng (TW); XIN-YUAN WU, Shenzhen City (CN); LU YANG, Shenzhen City (CN)

(21) Appl. No.: 13/629,652

(22) Filed: Sep. 28, 2012

(30) Foreign Application Priority Data
Dec. 26, 2011 (CN) 201110440929.2

(51) Int. Cl. G06F 17/50

(52) U.S. Cl. 703/1

(57) ABSTRACT

In a method for extracting a feature element of a product from a design drawing of the product, a point and a curved surface related to the feature element are selected from the design drawing. The method calculates a minimum distance between the selected point and an outline of the selected curved surface, and identifies whether the selected curved surface or the outline is the feature element by comparing the minimum distance with a first preset value. The method further determines a measuring type of the feature element according to a point cloud of the feature element, and extracts sample points composed of the feature element according to the measuring type and attribute data of the feature element. The sample points are output on a display screen of the computing device.

### BACKGROUND

1. Technical Field

Embodiments of the present disclosure generally relate to measurement management, and more particularly to a computing device and a method for extracting feature elements of a product from a design drawing of the product.

2. Description of Related Art

In automated processes, a workpiece (such as a product) on a production line needs to be carefully measured The measurements are stored in a point cloud, and a computer can then examine feature elements of the product to ensure that quality of the product is within predetermined tolerances. However, it is difficult to accurately measure boundary points of the product. Furthermore, each measuring point of the product must be extracted manually, and a measuring type of the product is difficult to identify. Therefore, an improved extraction method is desirable to address the aforementioned issues.

### BRIEF DESCRIPTION OF THE DRAWINGS

FIG. 1 is a block diagram of one embodiment of a computing device including an extracting unit.

FIG. 2 is a flowchart illustrating one embodiment of a method for extracting a feature element of a product from a design drawing of the product.

FIG. 3 illustrates an example of selecting a point and a curved surface from a design drawing of a product.

FIG. 4 is a detailed description of block S9 in FIG. 2, for determining a measuring type of a curved surface.

FIG. 5 illustrates an example of identifying a curved surface.

FIG. 6 is a detailed description of block S13 in FIG. 2, for determining a measuring type of an outline of a curved surface.

FIG. 7 illustrates an example of identifying an outline of a curved surface.

FIG. 8, FIG. 9, and FIG. 10 illustrate examples of extracting sample points composed of a feature element.

### DETAILED DESCRIPTION

In general, the term “module,” as used herein, refers to logic embodied in hardware or firmware, or to a collection of software instructions, written in a programming language, such as, for example, Java, C, or assembly. One or more software instructions in the modules may be embedded in firmware, such as in an erasable-programmable read-only memory (EPROM). It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or computer storage device.

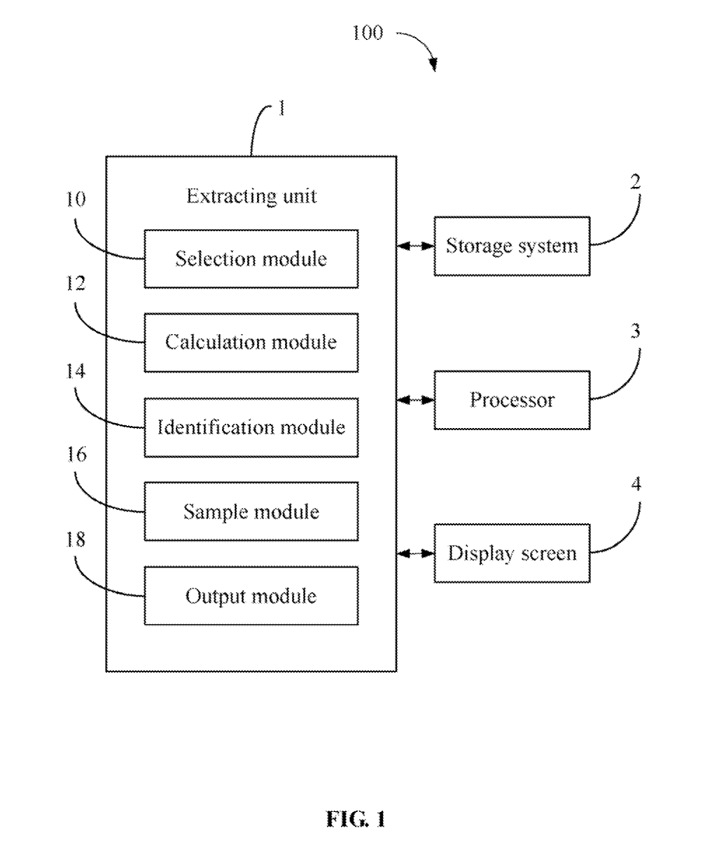

FIG. 1 is a block diagram of one embodiment of a computing device 100 including an extracting unit 1. In the embodiment, functions of the extracting unit 1 are implemented by the computing device 100. By selecting a point and a curved surface from a design drawing of a product, the extracting unit 1 can identify which feature element to extract, determine a measuring type of the feature element, and extract the feature element from the design drawing according to the measuring type and attribute data of the feature element. In order to quickly complete a measurement of the product, a plurality of sample points are extracted from the feature element and then are measured. In the embodiment, the sample points are feature points of the feature element. A rule for extracting the sample points can be preset according to users' requirement. The rule defines an interval of extracting the sample points.

In one embodiment, the computing device 100 may be a computer, a server, a portable electronic device, or any other electronic device that includes a storage system 2, at least one processor 3, and a display screen 4. In one embodiment, the storage system 2 may be a magnetic or an optical storage system, such as a hard disk drive, an optical drive, a compact disc, a digital video disc, a tape drive, or other suitable storage medium. The processor 3 may be a central processing unit including a math co-processor, for example. The display screen 4 displays the design drawing of the product, and feature elements of the product in the design drawing.

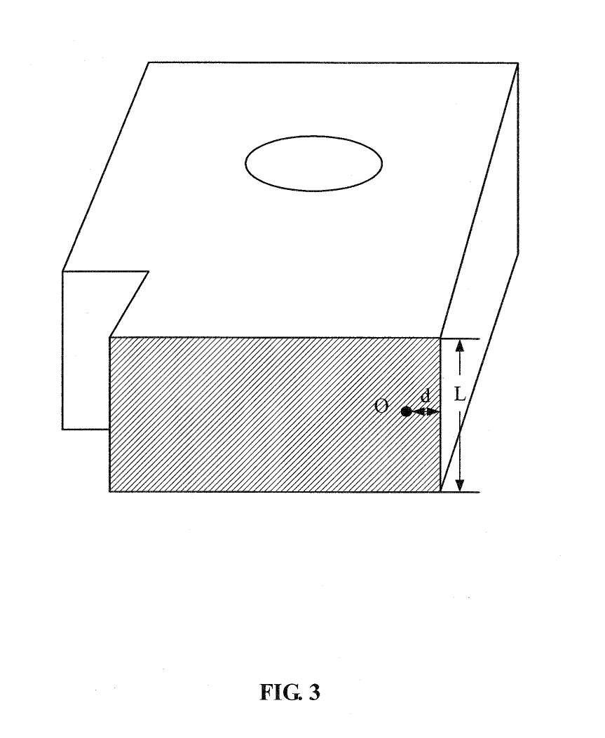

In the embodiment, the display screen 4 displays an operation interface for a user to select the point and the curved surface related to the feature element to be extracted from the design drawing, and displays the sample points extracted by the extracting unit 1 from the feature element. As shown in FIG. 3, a point “O” is the point selected by the user, a plane with shadow is the curved surface selected by the user, and “L” is a length of one boundary line of the curved surface.

In one embodiment, the feature element may be a curved surface, or an outline of the curved surface. In the embodiment, the outline of the curved surface is composed of boundary lines. Each feature element corresponds to a point cloud and attribute data. The point cloud is a collection of points that forms the feature element. The point cloud, the attribute data, the curved surface, and the outline of the curved surface are recorded as an attribute file of the product in the storage system 2. In the embodiment, the attribute file correlates to the design drawing of the product.

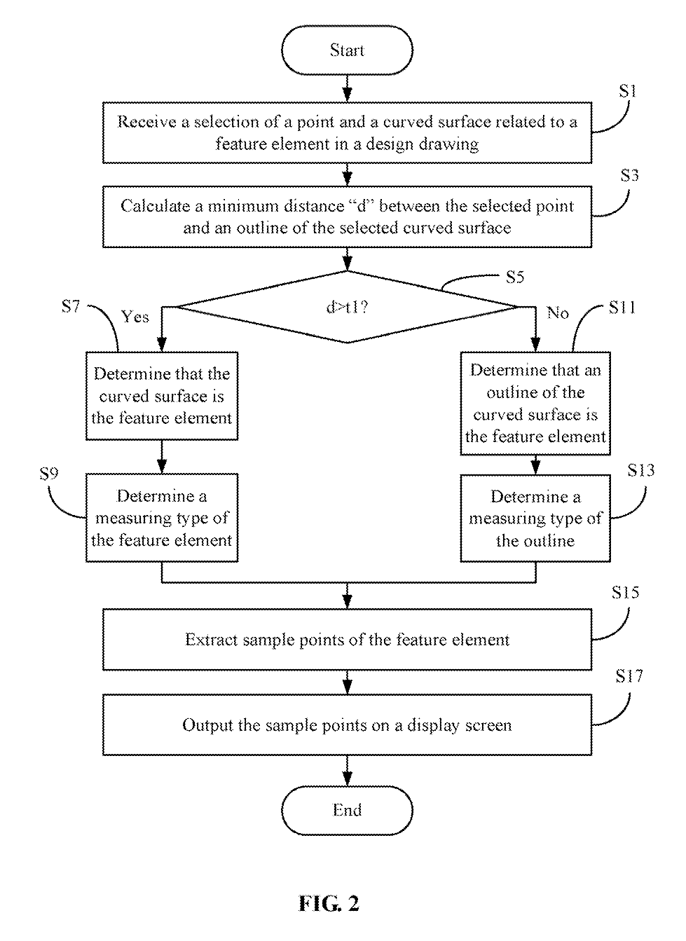

In one embodiment, the extracting unit 1 includes a selection module 10, a calculation module 12, an identification module 14, a sample module 16, and an output module 18. Each of the modules 10-18 may be a software program including one or more computerized instructions that are stored in the storage system 2 and executed by the processor 3. Detailed functions of the modules 10-18 are described below and shown in FIG. 2 to FIG. 10.

FIG. 2 is a flowchart illustrating one embodiment of a method for extracting a feature element from the design drawing of the product. The method can be performed by the execution of a computer-readable program by the at least one processor 3. Depending on the embodiment, in FIG. 2, additional blocks may be added, others removed, and the ordering of the blocks may be changed.

In step S1, the selection module 10 receives a selection of a point and a curved surface related to a feature element to be extracted from the design drawing. As illustrated in FIG. 3, the point “O” and the plane with shadow are selected from the design drawing by the user.

In step S3, the calculation module 12 calculates a minimum distance between the point and an outline of the selected curved surface. In detail, the calculation module 12 calculates the distances between the point and each boundary line of the selected curved surface, and finds the minimum distance from the calculated distances. As shown in FIG. 3, the calculation module 12 finds that the distance “d” between the point “O” and the boundary line “L” of the plane with shadow is the minimum distance.

In step S5, the identification module 14 identifies whether the selected curved surface or the outline of the selected curved surface is the feature element by comparing the minimum distance with a first preset value “t1”. In the embodiment, the first preset value “t1” is a preset minimum distance between the selected point and the feature element. Upon the condition that the minimum distance is greater than the first preset value “t1”, step S7 is implemented. Upon the condition that minimum distance is not greater than the first preset value “t1”, step S11 is implemented.

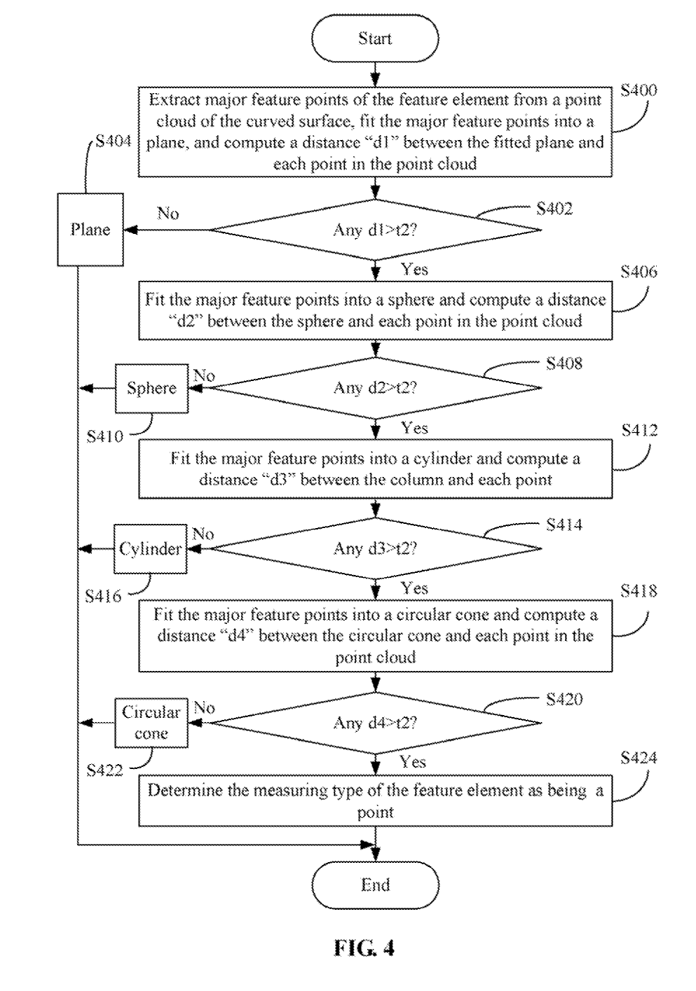

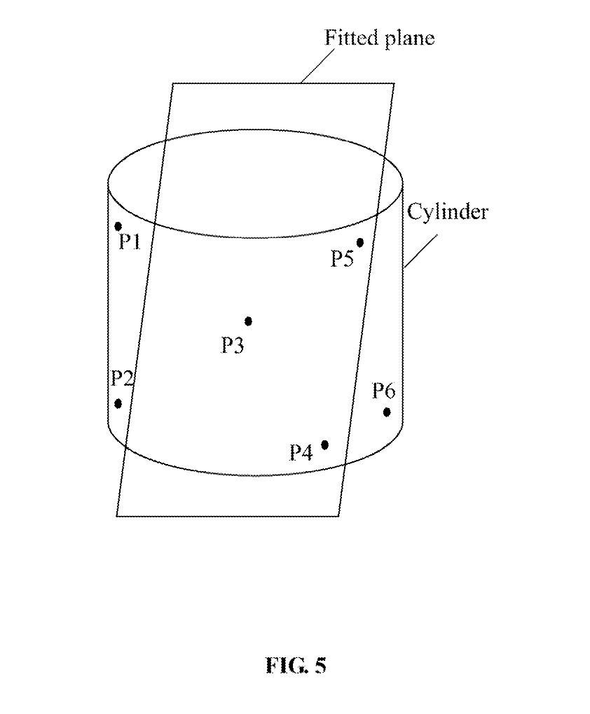

In step S7, the identification module 14 determines that the selected curved surface is the feature element to be extracted from the design drawing, and in step S9, the identification module 14 determines a measuring type of the feature element according to the point cloud of the curved surface. Details of how to determine the measuring type of the feature element is given in FIG. 4. In one embodiment, the measuring type may be a point, a plane, a circle, a sphere, a cylinder, or a circular cone.

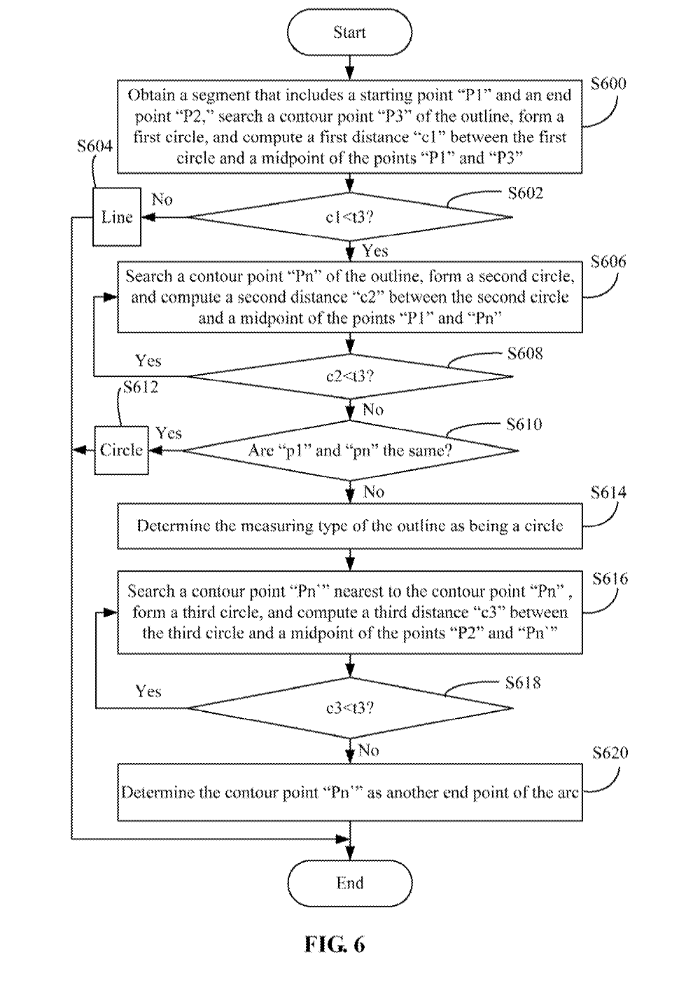

In step S11, the identification module 14 determines that the outline of the selected curved surface is the feature element, and in step S13, the identification module 14 determines the measuring type of the outline of the curved surface according to the point cloud of the outline. Details of how to determine the measuring type of the outline is given in FIG. 6. In one embodiment, the measuring type may be a line, a circle, or a arc.

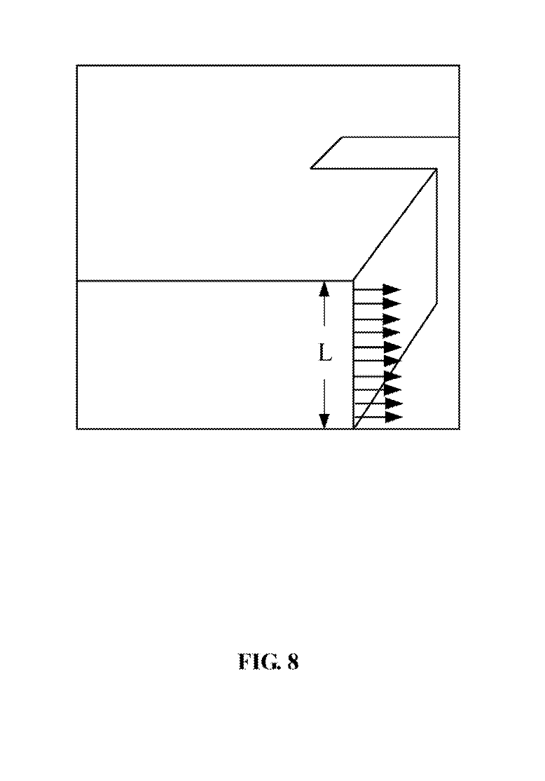

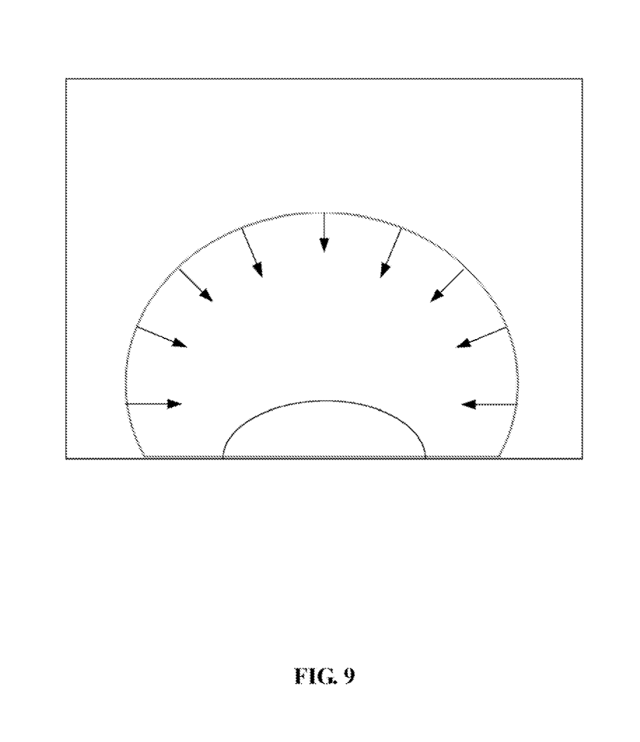

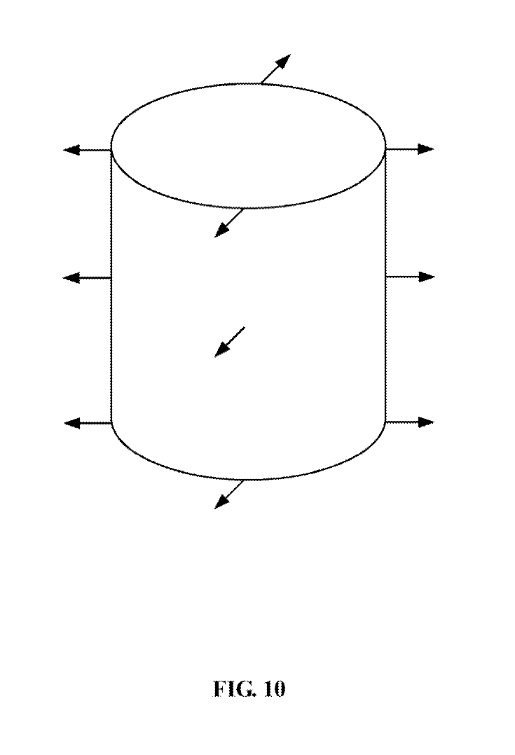

In step S15, the sample module 16 extracts sample points of the feature element according to the measuring type and the attribute data of the feature element. FIG. 8 illustrates an example of extracting sample points from a line. FIG. 9 illustrates an example of extracting sample points from an arc. FIG. 10 illustrates an example of extracting points from a cylinder. As illustrated in FIG. 8, FIG. 9, and FIG. 10, the sample points are arranged in uniformity.

In step S17, the output module 18 displays the sample points on the display screen 4.

FIG. 4 gives a detailed description of block S9 in FIG. 2, for determining a measuring type of a curved surface.

In step S400, the identification module 14 extracts a plurality of major feature points of the feature element from the point cloud of the curved surface. In one embodiment, the major feature points are inflection points of the curved surface. The identification module 14 fits the plurality of major feature points into a plane, and computes a distance “d1” between the fitted plane and each point in the point cloud of the curved surface.

In step S402, the identification module 14 compares each distance “d1” with a second preset value “t2,” and determines whether each distance “d1” is not greater than the second preset value “t2.” In the embodiment, the second preset value “t2” represents fitting precision. Upon the condition that each distance “d1” is not greater than the second preset value “t2,” step S404 is implemented. Upon the condition that any distance “d1” is greater than the second preset value “t2,” step S406 is implemented.

In step S404, the identification module 14 determines the measuring type of the feature element as a plane.

In step S406, the identification module 14 fits the plurality of major feature points of the feature element into a sphere, and computes a distance “d2” between the fitted sphere and each point in the point cloud of the curved surface.

In step S408, the identification module 14 determines whether each distance “d2” is not greater than the second preset value “t2.” Upon the condition that each distance “d2” is not greater than the second preset value “t2,” step S410 is implemented. Upon the condition that any distance “d2” is greater than the second preset value “t2,” step S412 is implemented.

In step S410, the identification module 14 determines the measuring type of the feature element as a sphere.

In step S412, the identification module 14 fits the plurality of major feature points of the feature element into a cylinder, and computes a distance “d3” between the fitted cylinder and each point in the point cloud of the curved surface.

In step S414, the identification module 14 determines whether each distance “d3” is not greater than the second preset value “t2.” Upon the condition that each distance “d3” is not more than the second preset value “t2,” step S416 is implemented. Upon the condition that any distance “d3” is greater than the second preset value “t2,” step S418 is implemented.

In step S416, the identification module 14 determines the measuring type of the feature element as a cylinder.

In step S418, the identification module 14 fits the plurality of major feature points of the feature element into a circular cone, and computes a distance “d4” between the fitted circular cone and each point in the point cloud of the curved surface.

In step S420, the identification module 14 determines whether each distance “d4” is not greater than the second preset value “t2.” Upon the condition that each distance “d4” is not greater than the second preset value “t2,” step S422 is implemented. Upon the condition that the distance “d4” is greater than the second preset value “t2,” step S424 is implemented.

In step S422, the identification module 14 determines the measuring type of the feature element as being a circular cone.

In step S424, the identification module 14 determines the measuring type of the feature element as being a point.

In the embodiment, an order of the plane fitting, the sphere fitting, the cylinder fitting, and the circular cone fitting can be adjusted.

FIG. 6 is a detailed description of block S13 in FIG. 2, for determining that the measuring type of the product is an outline of the curved surface.

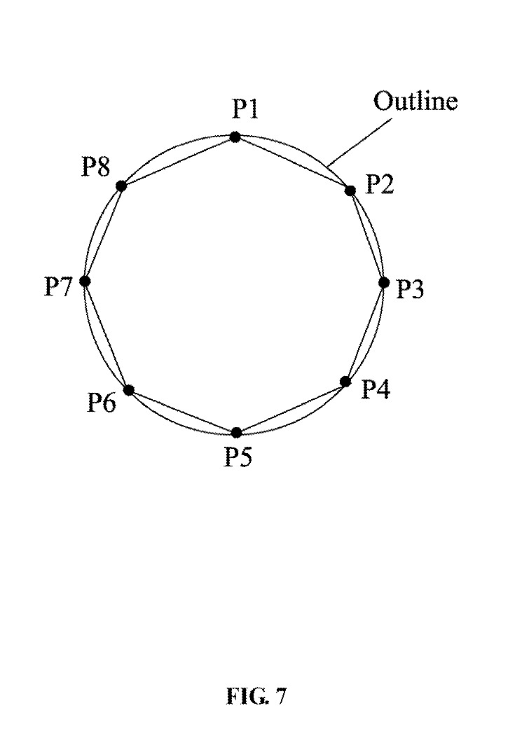

In step S600, the identification module 14 obtains a segment of the outline corresponding to the minimum distance computed in step S3 of FIG. 2. The segment includes a starting point “P1” and an end point “P2.” In the embodiment, the points “P1” and “P2” are two contour points on the outline. The identification module 14 searches for a contour point “P3” (as shown in FIG. 7) of the outline along a preset direction, forms a first circle according to the three points “P1,” “P2,” and “P3,” and computes a first distance “c1” between the first circle and a midpoint of the points “P1” and “P3.”

In the embodiment, the contour point P3 is nearest to the end point “P2.” The preset direction may be clockwise or counter clockwise.

In step S602, the identification module 14 compares the first distance “c1” with a third preset value “t3,” and determines whether the first distance “c1” is less than the third preset value “t3.” In the embodiment, the third preset value “t3” is a fitting precision for fitting the circle or an arc based on searched points. In other words, the third preset value “t3” is the maximum allowable deviation from the precise location of the searched points on the circumference of a circle or arc.

Upon the condition that first distance “c1” is not less than the third preset value “t3,” in step S604, the identification module 14 determines the measuring type of the outline as being a line. Upon the condition that the first distance “c1” is less than the third preset value “t3,” step S606 is implemented.

In step S606, the identification module 14 searches for a contour point “Pn” of the outline along the preset direction, forms a second circle according to the points “P1,” “P2,” “P3,” and “Pn,” and computes a second distance “c2” between the second circle and a midpoint of the points “P1” and “Pn.” For example, if “n” equals four, the identification forms the second circle based on the points “P1,” “P2,” “P3,” and “P4,” and computes the second distance “c2” between the second circle and the midpoint of the points P1 and P4.

In step S608, the identification module 14 determines whether the second distance “c2” is less than the third preset value “t3.” Upon the condition that the second distance “c2” is less than the third preset value “t3,” the flow returns to step S606. Upon the condition that the second distance “c2” is greater than or equal to the third preset value “t3,” in step S610, the identification module 14 determines whether the point “Pn” and the point “P1” are the same.

Upon the condition that the point “Pn” and the point “P1” are the same, in step S612, the identification module 14 determines the measuring type of the outline as being a circle. Upon the condition that the point “Pn” and the point “P1” are not the same, in step S614, the identification module 14 determines the measuring type of the outline as being an arc. The point “P1” is an end point of the arc. Another end point of the arc is determined according to step S620.

In step S616, the identification module 14 searches for a contour point “Pn′” that is nearest to the contour point “Pn” along the direction that is opposite to the preset direction, forms a third circle according to the points “P2,” “P1,” and “Pn′,” and computes a third distance “c3” between the third circle and a midpoint of the points “P2” and “Pn′”.

In step S618, the identification module 14 determines whether the third distance “c3” is less than the third preset value “t3.” Upon the condition that the third distance “c3” is less than the third preset value “t3,” the flow returns to step S616. Upon the condition that the third distance “C3” is greater than or equal to the preset value “t2,” in step S620, the identification module 14 determines the contour point “Pn′” as being the other end point of the arc.

Although certain inventive embodiments of the present disclosure have been specifically described, the present disclosure is not to be construed as being limited thereto.

Various changes or modifications may be made to the present disclosure without departing from the scope and spirit of the present disclosure.

What is claimed is:

1. A method of a computing device for extracting a feature element of a product from a design drawing of the product, the method comprising steps of:
receiving a selection of a point and a curved surface related to the feature element in the design drawing;
calculating a minimum distance between the selected point and an outline of the selected curved surface;
identifying whether the selected curved surface or the outline of the selected curved surface is the feature element in the design drawing by comparing the minimum distance with a first preset value;
determining a measuring type of the feature element according to a point cloud of the feature element;
extracting sample points composed of the feature element according to the measuring type and attribute data of the feature element; and
displaying the sample points on a display screen of the computing device.

2. The method as described in claim 1, wherein the step of identifying whether the selected curved surface or the outline of the selected curved surface is the feature element comprises:
determining that the selected curved surface is the feature element, upon the condition that the minimum distance is greater than the first preset value; and
determining that the outline of the selected curved surface is the feature element, upon the condition that the minimum distance is less than or equal to the first preset value.

3. The method as described in claim 2, wherein when the selected curved surface is the feature element, the step of determining the measuring type of the feature element comprises:
extracting a plurality of major feature points of the feature element from the point cloud of the curved surface;
fitting the plurality of major feature points into a plane, and computing a first distance between the fitted plane and each point in the point cloud of the curved surface;
determining the measuring type of the feature element as being the plane, upon the condition that each first distance is less than or equal to a second preset value;
fitting the plurality of major feature points of the feature element into a sphere, and computing a second distance between the fitted sphere and each point in the point cloud of the curved surface, upon the condition that any first distance is greater than the second preset value;
determining the measuring type of the feature element as being the sphere, upon the condition that each second distance is less than or equal to the second preset value;
fitting the plurality of major feature points of the feature element into a cylinder, and computing a third distance between the fitted cylinder and each point in the point cloud of the curved surface, upon the condition that any second distance is greater than the second preset value;
determining the measuring type of the feature element as being the cylinder, upon the condition that each third distance is less than or equal to the second preset value;
fitting the plurality of major feature points of the feature element into a circular cone, and computing a forth distance between the fitted circular cone and each point in the point cloud of the curved surface, upon the condition that any third distance is greater than the second preset value;
determining the measuring type of the feature element as being the circular cone, upon the condition that each forth distance is less than or equal to the second preset value; or determining the measuring type of the feature element as being the point, upon the condition that any forth distance is greater than the second preset value.

4. The method as described in claim 2, wherein when the outline of the selected curved surface is the feature element, the step of determining the measuring type of the feature element comprises:
(a2) obtaining a segment of the outline that is corresponding to the minimum distance between the selected point and the outline of the selected curved surface, the segment comprising a starting point “P1” and an end point “P2” that are contour points of the outline;
(b2) searching a contour point “P3” of the outline along a preset direction, the contour point “P3” being nearest to the end point “P2”;
(c2) forming a first circle according to the three points “P1,” “P2,” and “P3,” and computing a first distance between the first circle and a midpoint of the points “P1” and “P3”;
(d2) determining the measuring type of the outline as being a line, upon the condition that the first distance is less than a third preset value;
(e2) searching a contour point “Pn” of the outline along the preset direction, and forming a second circle according to the points “P1,” “P2,” “P3,” and “Pn,” upon the condition that the first distance is greater than or equal to the third preset value;
(f2) computing a second distance between the second circle and a midpoint of the points “P1” and “Pn”;
(g2) implementing step (e2) to step (g2) till the second distance is greater than or equal to the third preset value, upon the condition that the second distance is less than the third preset value.
(h2) determining the measuring type of the outline as being a circle, upon the condition that the point “Pn” and the point “P1” are the same; or
(i2) determining the measuring type of the outline as an arc, upon the condition that the second distance is greater than or equal to the third preset value, and the points “Pn” and “P1” are not the same;
(j2) searching a contour point “Pn′” that is nearest to the contour point “Pn” along a direction that is opposite to the preset direction, and forming a third circle according to the points “P2,” “P1,” and “Pn′”, computing a third distance between the third circle and a midpoint of the points “P2” and “Pn′”;
(k2) implementing step (j2) to step (k2) till the third distance is greater than or equal to the third preset value, upon the condition that the third distance is less than the third preset value; and
(12) determining the contour point “Pn′” as an end point of the arc, upon the condition that the third distance is greater than or equal to the third preset value.

5. A computing device, comprising:
at least one processor;
a storage system;
a display screen; and
one or more modules that are stored in the storage system and executed by the at least one processor, the one or more modules comprising:
a selection module that receives a selection of a point and a curved surface related to the feature element in the design drawing;
a calculation module that calculates a minimum distance between the selected point and an outline of the selected curved surface;
an identification module that identifies whether the selected curved surface or the outline of the selected curved surface is the feature element by comparing the minimum distance with a first preset value;
the identification module that further determines a measuring type of the feature element according to a point cloud of the feature element;
a sample module that extracts sample points composed of the feature element according to the measuring type and attribute data of the feature element; and
an output module that displays the sample points on the display screen.

6. The computing device as described in claim 5, wherein the identification module identifies whether the feature element is the selected curved surface or the outline of the selected curved surface by:
determining that the selected curved surface is the feature element, upon the condition that the minimum distance is greater than the first preset value; and
determining that the outline of the selected curved surface is the feature element, upon the condition that the minimum distance is less than or equal to the first preset value.

7. The computing device as described in claim 6, wherein when the selected curved surface is the feature element, the identification module determines the measuring type of the feature element by:
extracting a plurality of major feature points of the feature element from the point cloud of the curved surface;
fitting the plurality of major feature points into a plane, and computing a first distance between the fitted plane and each point in the point cloud of the curved surface;
determining the measuring type of the feature element as being the plane, upon the condition that each first distance is less than or equal to a second preset value;
fitting the plurality of major feature points of the feature element into a sphere, and computing a second distance between the fitted sphere and each point in the point cloud of the curved surface, upon the condition that any first distance is greater than the second preset value;
determining the measuring type of the feature element as being the sphere, upon the condition that each second distance is less than or equal to the second preset value;
fitting the plurality of major feature points of the feature element into a cylinder, and computing a third distance between the fitted cylinder and each point in the point cloud of the curved surface, upon the condition that any second distance is greater than the second preset value;
determining the measuring type of the feature element as being the cylinder, upon the condition that each third distance is less than or equal to the second preset value;
fitting the plurality of major feature points of the feature element into a circular cone, and computing a forth distance between the fitted circular cone and each point in the point cloud of the curved surface, upon the condition that any third distance is greater than the second preset value;
determining the measuring type of the feature element as being the circular cone, upon the condition that each forth distance is less than or equal to the second preset value; or determining the measuring type of the feature element as being the point, upon the condition that any forth distance is greater than the second preset value.

8. The computing device as described in claim 6, wherein when the outline of the selected curved surface is the feature element, the identification module determines the measuring type of the feature element by:
(a2) obtaining a segment of the outline that is corresponding to the minimum distance between the selected point and the outline of the selected curved surface, the segment comprising a starting point “P1” and an end point “P2” that are contour points of the outline;
(b2) searching a contour point “P3” of the outline along a preset direction, the contour point “P3” being nearest to the end point “P2”;
(c2) forming a first circle according to the three points “P1,” “P2,” and “P3,” and computing a first distance between the first circle and a midpoint of the points “P1” and “P3”;
(d2) determining the measuring type of the outline as being a line, upon the condition that the first distance is less than a third preset value;
(e2) searching a contour point “Pn” of the outline along the preset direction, and forming a second circle according to the points “P1,” “P2,” “P3,” and “Pn,” upon the condition that the first distance is greater than or equal to the third preset value;
(f2) computing a second distance between the second circle and a midpoint of the points “P1” and “Pn”;
(g2) implementing step (e2) to step (g2) till the second distance is greater than or equal to the third preset value, upon the condition that the second distance is less than the third preset value.
(h2) determining the measuring type of the outline as being a circle, upon the condition that the point “Pn” and the point “P1” are the same; or
(i2) determining the measuring type of the outline as an arc, upon the condition that the second distance is greater than or equal to the third preset value, and the points “Pn” and “P1” are not the same;
(j2) searching a contour point “Pn′” that is nearest to the contour point “Pn” along a direction that is opposite to the preset direction, and forming a third circle according to the points “P2,” “P1,” and “Pn′”, computing a third distance between the third circle and a midpoint of the points “P2” and “Pn′”;
(k2) implementing step (j2) to step (k2) till the third distance is greater than or equal to the third preset value, upon the condition that the third distance is less than the third preset value; and
(l2) determining the contour point “Pn′” as an end point of the arc, upon the condition that the third distance is greater than or equal to the third preset value.

9. A non-transitory storage medium having stored thereon instructions that, when executed by a processor of a computing device, causes the computing device to perform a method for extracting a feature element of a product from a design drawing of the product, the method comprising:
receiving a selection of a point and a curved surface related to the feature element in the design drawing;
calculating a minimum distance between the selected point and an outline of the selected curved surface;
identifying whether the selected curved surface or the outline of the selected curved surface is the feature element in the design drawing by comparing the minimum distance with a first preset value;
determining a measuring type of the feature element according to a point cloud of the feature element;
extracting sample points composed of the feature element according to the measuring type and attribute data of the feature element; and
displaying the sample points on a display screen of the computing device.

10. The non-transitory storage medium as described in claim 9, wherein the step of identifying whether the feature element is the selected curved surface or the outline of the selected curved surface comprises:
determining that the selected curved surface is the feature element, upon the condition that the minimum distance is greater than the first preset value; and
determining that the outline of the selected curved surface is the feature element, upon the condition that the minimum distance is less than or equal to the first preset value.

11. The non-transitory storage medium as described in claim 10, wherein when the selected curved surface is the feature element, the step of determining the measuring type of the feature element comprises:
extracting a plurality of major feature points of the feature element from the point cloud of the curved surface;
fitting the plurality of major feature points into a plane, and computing a first distance between the fitted plane and each point in the point cloud of the curved surface;
determining the measuring type of the feature element as being the plane, upon the condition that each first distance is less than or equal to a second preset value;
fitting the plurality of major feature points of the feature element into a sphere, and computing a second distance between the fitted sphere and each point in the point cloud of the curved surface, upon the condition that any first distance is greater than the second preset value;
determining the measuring type of the feature element as being the sphere, upon the condition that each second distance is less than or equal to the second preset value;
fitting the plurality of major feature points of the feature element into a cylinder, and computing a third distance between the fitted cylinder and each point in the point cloud of the curved surface, upon the condition that any second distance is greater than the second preset value;
determining the measuring type of the feature element as being the cylinder, upon the condition that each third distance is less than or equal to the second preset value;
fitting the plurality of major feature points of the feature element into a circular cone, and computing a forth distance between the fitted circular cone and each point in the point cloud of the curved surface, upon the condition that any third distance is greater than the second preset value;
determining the measuring type of the feature element as being the circular cone, upon the condition that each forth distance is less than or equal to the second preset value; or determining the measuring type of the feature element as being the point, upon the condition that any forth distance is greater than the second preset value.

12. The non-transitory storage medium as described in claim 11, wherein when the outline of the selected curved surface is the feature element, the step of determining a measuring type of the feature element comprises:
(a2) obtaining a segment of the outline that is corresponding to the minimum distance between the selected point and the outline of the selected curved surface, the segment comprising a starting point “P1” and an end point “P2” that are contour points of the outline;
(b2) searching a contour point “P3” of the outline along a preset direction, the contour point “P3” being nearest to the end point “P2”;
(c2) forming a first circle according to the three points “P1,” “P2,” and “P3,” and computing a first distance between the first circle and a midpoint of the points “P1” and “P3”;
(d2) determining the measuring type of the outline as being a line, upon the condition that the first distance is less than a third preset value;
(e2) searching a contour point “Pn” of the outline along the preset direction, and forming a second circle according to the points “P1,” “P2,” “P3,” and “Pn,” upon the condition that the first distance is greater than or equal to the third preset value;
(f2) computing a second distance between the second circle and a midpoint of the points “P1” and “Pn”;
(g2) implementing step (e2) to step (g2) till the second distance is greater than or equal to the third preset value, upon the condition that the second distance is less than the third preset value.
(h2) determining the measuring type of the outline as being a circle, upon the condition that the point “Pn” and the point “P1” are the same; or
(i2) determining the measuring type of the outline as an arc, upon the condition that the second distance is greater than or equal to the third preset value, and the points “Pn” and “P1” are not the same;
(j2) searching a contour point “Pn′” that is nearest to the contour point “Pn” along a direction that is opposite to the preset direction, and forming a third circle according to the points “P2,” “P1,” and “Pn′”, computing a third distance between the third circle and a midpoint of the points “P2” and “Pn′”;
(k2) implementing step (j2) to step (k2) till the third distance is greater than or equal to the third preset value, upon the condition that the third distance is less than the third preset value; and
(l2) determining the contour point “Pn′” as an end point of the arc, upon the condition that the third distance is greater than or equal to the third preset value.
